(19) United States
(12) Patent Application Publication
(10) Pub. No.: US 2021/0264367 A1
(43) Pub. Date: Aug. 26, 2021

(54) WORKFLOW PROCESSING USING UNIQUE IDENTIFIERS

(71) Applicant: Wells Fargo Bank, N.A., Charlotte, NC (US)

(72) Inventors: Cameron H. River, Woodland Hills, CA (US); Michael Paltayan, Van Nuys, CA (US)

(21) Appl. No.: 15/062,931

(22) Filed: Mar. 7, 2016

Related U.S. Application Data
(60) Provisional application No. 62/259,418, filed on Nov. 24, 2015.

(51) Int. Cl. G06Q 10/10; H04L 12/58

(52) U.S. Cl. CPC G06Q 10/103; H04L 51/24; G06Q 10/107

(57) ABSTRACT

Systems and methods of managing workflow tasks and decisions. A workflow system generates a workflow with tasks assigned to users. The tasks have options for responding to the task to be obtained from the assigned users in order to the complete or update the task. Each option is assigned a unique identifier that also corresponds to each assigned user, such that one unique identifier identifies one option and one user. Links to select an option are sent to the user along with the unique identifiers. When a response is received, the unique identifier is returned and is checked for a match with the unique identifier sent. The workflow system processes the response when the unique identifiers match.

### CROSS-REFERENCE TO RELATED APPLICATIONS

This application claims the benefit of U.S. Provisional Patent Application Ser. No. 62/259,418 entitled “WORKFLOW PROCESSING USING UNIQUE IDENTIFIERS” filed on Nov. 24, 2015. The entirety of the above-noted application is incorporated by reference herein.

### BACKGROUND

Managing workflow tasks is a tedious process. The difficulty resides in coordinating multiple parties for the different documents and/or steps until a project is complete. Even more difficulty resides in authenticating task responses. For approval of documents or completion of a task in the workflow, parties assigned with the task must approve or deny the task. It is important to ensure the correct assigned parties are responding to the right tasks.

### BRIEF DESCRIPTION

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

In a typical workflow within a group or organization, a decision or set of decisions from one person or group of persons needs to be made before the next person in the workflow is provided a task or request that needs to be completed for his or her stage of a workflow. At times, several people may need to provide a response or approval at a particular workflow task before the next task in the workflow can begin. In the subject innovation, each decision point option in a workflow is assigned a user-specific global unique identifier (GUID) that is associated with a selectable link in the workflow. For example, Person A may be required to approve or deny a document or status. When Person A selects the link for “approve,” for example, a unique identifier that is specific to Person A and is also associated with the link is sent (e.g. via email) to a component that collects responses in the workflow. Person B may be required to provide approval or disapproval of the same document or status, but if Person B selects the “approve” link, the unique identifier sent from Person B is different from the unique identifier sent from Person A. A decision processing component matches the unique identifiers received to the username associated with the unique identifiers (e.g., Person A or Person B) to confirm that the workflow approval request was not forwarded to another user.

In aspects, the subject innovation provides substantial benefits in terms of workflow processing and management. One advantage resides in having unique identifiers to separately authenticate decision point responses. Another advantage resides in managing approvals within the workflow.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

Aspects of the disclosure are understood from the following detailed description when read with the accompanying drawings. It will be appreciated that elements, structures, etc. of the drawings are not necessarily drawn to scale. Accordingly, the dimensions of the same may be arbitrarily increased or reduced for clarity of discussion, for example.

FIG. 1 illustrates an input/output diagram for managing workflows.

FIG. 2 illustrates an example component diagram of workflow system.

FIG. 3 illustrates an example component diagram of a decision processing component.

FIG. 4 illustrates a flowchart for processing a workflow with unique identifiers.

FIG. 5 illustrates a computer-readable medium or computer-readable device comprising processor-executable instructions configured to embody one or more of the provisions set forth herein, according to some embodiments.

FIG. 6 illustrates a computing environment where one or more of the provisions set forth herein can be implemented, according to some embodiments.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, or a computer. By way of illustration, both an application running on a controller and the controller can be a component. One or more components residing within a process or thread of execution and a component may be localized on one computer or distributed between two or more computers.

Furthermore, the claimed subject matter can be implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

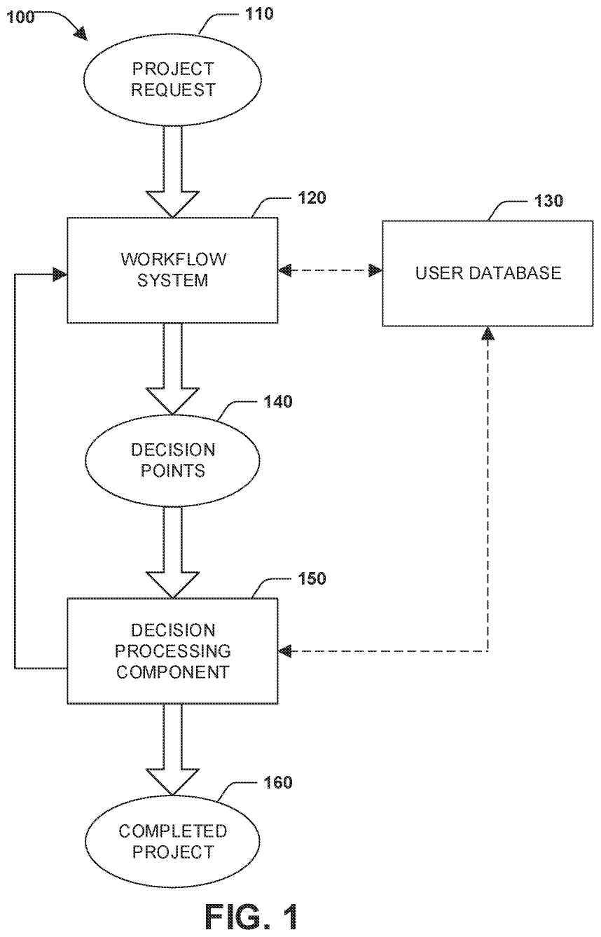

With reference to FIG. 1, an input/output diagram 100 for managing workflows is depicted. A project request 110 is received by a workflow system 120 to generate and manage a workflow for a project. The project request 110 can be a financial transaction, a set of documents, one larger document, a form, and/or the like.

The workflow system 120 receives the project request 110 for processing. The workflow system 120 divides the workflow into tasks, e.g. steps, for completing the project. In one embodiment, the tasks can be an ordered set of decisions and/or approvals. In another embodiment, the tasks can be a series of documents to be prepared. In yet another embodiment, the tasks can be completing different portions of a larger document and/or form.

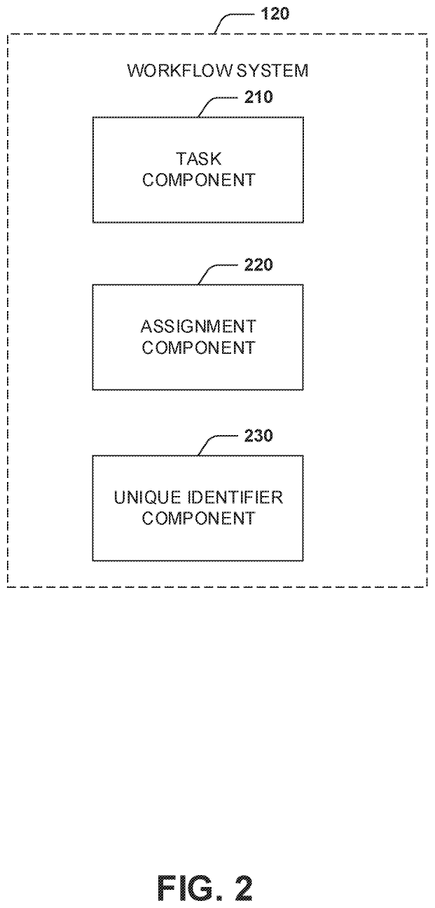

With reference to FIG. 2 and continuing reference to FIG. 1, a component diagram of the workflow system 120 is depicted. The workflow system 120 includes a task component 210. The task component 210 divides the workflow into tasks as described above. For example, the task component 210 can determine tasks for completing separate sections of a document. In one embodiment, the task component 210 generates a new task after a preceding task is completed. In another embodiment, the task component 210 generates every task when the project request 110 is received.

The workflow system 120 includes an assignment component 220. The assignment component 220 accesses the user database 130. The user database 130 includes information about users that can be assigned tasks. The user database 130 includes identification information about each user. The information includes contact information such as phone number, email address, company identification number, social security number, and/or the like. The assignment component 220 assigns tasks to users in the user database 130 for the users to complete and/or give a response, e.g. approve or deny, on the task.

The workflow system 120 includes a unique identifier component 220. The unique identifier component 230 generates decision points for each task. The unique identifier component 230 generates a decision point for each decision to be made on a task. For example, a decision point can be to approve or deny a document or a portion of a document before the workflow can proceed to the next task.

The unique identifier component 230 associates unique identifiers with decision point options. In one embodiment, the unique identifier component 230 generates the unique identifier upon creation of a decision point. In another embodiment, the unique identifier component 230 iterates a unique identifier from a list of pre-generated unique identifiers. The unique identifiers link a user to decision point option responding to a task. For example, User A is assigned a task, by the assignment component 220, to approve or deny a document before it is sent to a customer. The unique identifier component 230 generates a decision point for the approval or denial that User A must respond to. The unique identifier component 230 generates a unique identifier for the approval and another unique identifier for the denial, where both unique identifiers are associated with User A.

The workflow system 120 outputs the decision points 140 with unique identifiers 140 for each decision point option, e.g. approve/deny. In one embodiment, multiple decisions points are created for the same task such that multiple users can give responses about the same task. A decision processing component 150 receives the decision points from the workflow system 120. The decision processing component manages and/or coordinates the completion of tasks via responses to the decision points 140.

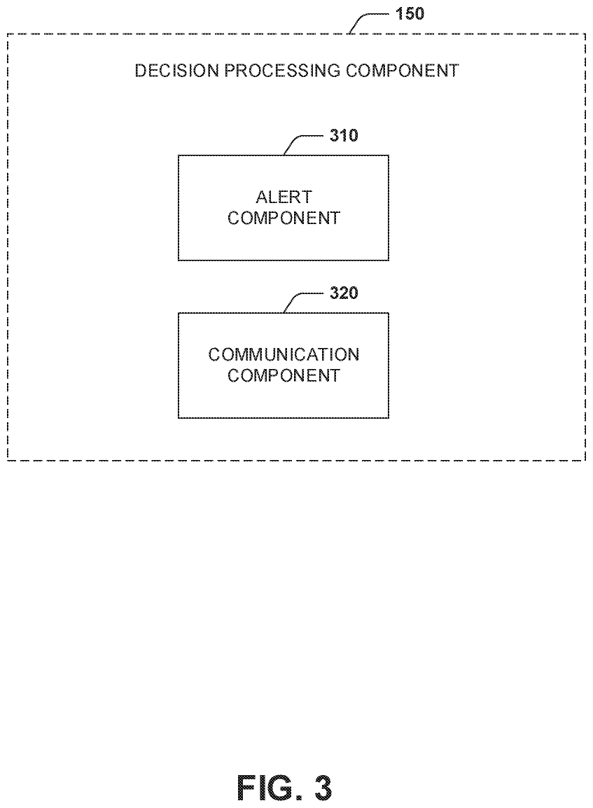

With reference to FIG. 3, and continuing reference to FIG. 1, the decision processing component 150 includes an alert component 310. The alert component 310 generates an alert to the user assigned with completing a task. The alert component 310 generates selectable links to the decision point options to be included in the alert. The selectable links contain the unique identifiers associated with the decision point options such that a user may select the link for the desired decision. The generated alert can be an email, a SMS, a push notification to an application provided to the user, or the like. For example, the alert component 310 generates an alert as an email to be emailed to User A at User A′s email address. The email can include a selectable link for approval and a selectable link for denial of a tasked document. The selectable links for approval and denial contains the unique identifier corresponding to the approval decision point option and associated with User A.

The decision processing component 150 includes a communication component 320. The communication component 320 accesses the user database 130 to retrieve contact information of the user to communicate the alert. The communication component 320 sends the generated alert to the user at the user's contact. The alert includes the selectable links associated with the unique identifier matching the user. The alert includes a selectable link for each decision point option for the task.

The communication component 320 receives responses from the user in the form of a selection of one of the decision point options. In one embodiment, the selection is made via the user clicking on one of the provided selectable links in the alert. The response includes the unique identifier for the selectable link. In one embodiment, the response also includes the originating contact information. For example, when a selectable link is selected from an email, a response is generated such that the response includes the unique identifier associated with the selectable link and the email address where the selectable link was selected. The communications component 320 matches the unique identifier to a stored unique identifier associated with the user to authenticate that the correct user has responded to the decision point. The communications component 320 can match the email address to the email address of the user from which a response was expected.

When a response is received and authenticated by the communication component 320, the decision processing component 150 updates the workflow system 120 with the response to the decision point. In one embodiment, the workflow system 120 iterates to a sequential task in the workflow until the workflow is completed 160. For example, when an initial task is completed, e.g. when an “approval” response is selected, the workflow system 120 generates a subsequent task in the workflow to be assigned decision points, assigned a user, and sent to the assigned user for a response.

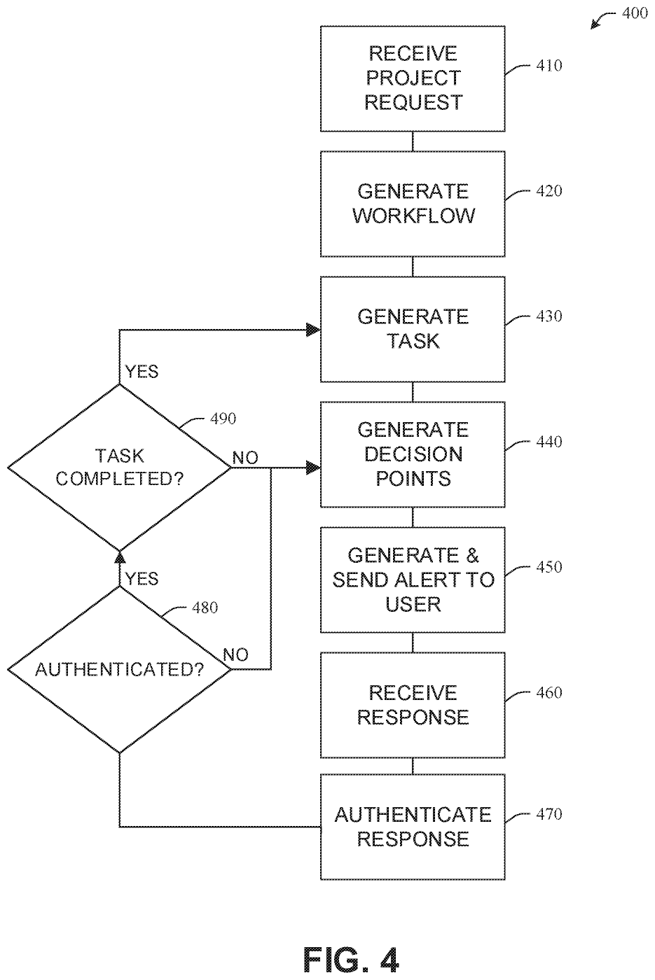

With reference to FIG. 4, an example method 400 is depicted for processing a workflow with unique identifiers. While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation. It is also appreciated that the method 400 is described in conjunction with a specific example is for explanation purposes.

In aspects, method 400 can begin at 410 by receiving a project request. For example, a series of forms must be completed to offer a business loan to a customer. At 420, a workflow for completing the project is generated. At 430, generating the workflow includes generating a task or multiple tasks for completing the project. The task is assigned to a user for completion or to give approval of the task. Continuing the example, a task can be generated for each form to be completed and assigned to a user or users.

At 440, decision points and/or decision point options for each task are generated. A unique identifier is associated with each decision point option. In the specific example, for each form a decision point is created where decision point options are approve or deny. A unique identifier is associated with the approve option and another unique identifier is associated with the deny option. Each unique identifier is associated with the user assigned to the task. In the continuing example, a unique identifier is associated with a user and an approval decision point option. Another unique identifier is associated with the same user and a denial decision point option.

At 450, an alert is generated and sent to the user assigned with the task. The alert includes selectable links for each decision point option that contain the unique identifiers. In the example, the selectable links are included in an email. The user can click on a selectable link to provide their desired response. At 460, a response is received from the user. The response is generated and sent upon the user clicking on one of the selectable links.

At 470, the response is authenticated. The response is authenticated by comparing the unique identifier associated with the selectable link with the expected user providing the response and the specific decision point option associated with the selectable link. In the example, the unique identifier associated for approval of a form and associated with the user. The response contains the unique identifier which is checked against the stored unique identifier to determine a match. The response can be further authenticated by comparing the responding user's contact information against an expected responding user to determine if they match. For example, a user response with a selection of a selectable link is received. The response is generated through email, and the email address is checked for a match with the assigned user's email address in a user database.

At 480, the method 400 checks whether the response was authenticated as described above. If “no,” the method returns to 440 to regenerate unique identifiers for decision point options and proceed through the method. If “yes,” the method checks whether the task was completed at 490. If “no,” the method returns to 440 to regenerate unique identifiers for decision point options and proceed through the method. If “yes,” the method returns to 430 to generate a new task or proceed to a subsequent task in the workflow. In one embodiment, the method will iterate through the tasks until the workflow is complete.

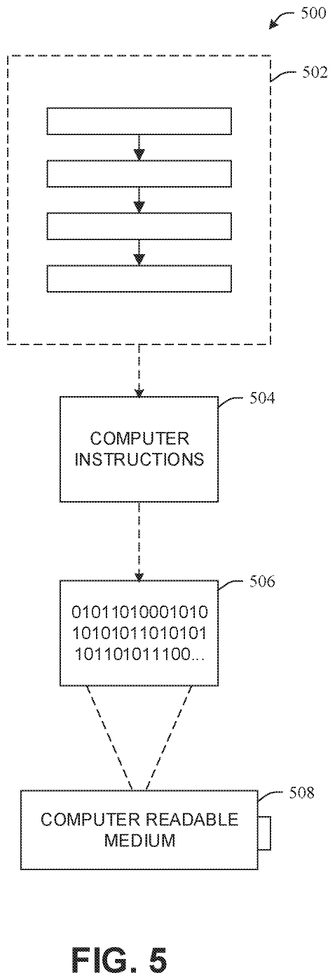

Still another embodiment can involve a computer-readable medium comprising processor-executable instructions configured to implement one or more embodiments of the techniques presented herein. An embodiment of a computer-readable medium or a computer-readable device that is devised in these ways is illustrated in FIG. 5, wherein an implementation 500 comprises a computer-readable medium 508, such as a CD-R, DVD-R, flash drive, a platter of a hard disk drive, etc., on which is encoded computer-readable data 506. This computer-readable data 506, such as binary data comprising a plurality of zero's and one's as shown in 506, in turn comprises a set of computer instructions 504 configured to operate according to one or more of the principles set forth herein. In one such embodiment 500, the processor-executable computer instructions 504 is configured to perform a method 502, such as at least a portion of one or more of the methods described in connec6tion with embodiments disclosed herein. In another embodiment, the processor-executable instructions 504 are configured to implement a system, such as at least a portion of one or more of the systems described in connection with embodiments disclosed herein. Many such computer-readable media can be devised by those of ordinary skill in the art that are configured to operate in accordance with the techniques presented herein.

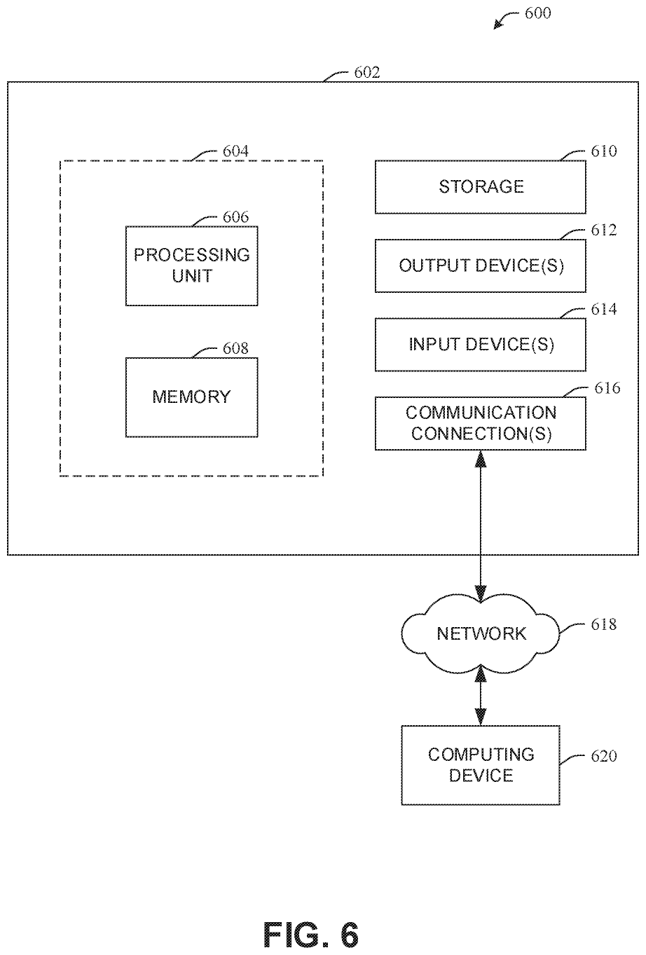

With reference to FIG. 6 and the following discussion provide a description of a suitable computing environment in which embodiments of one or more of the provisions set forth herein can be implemented. The operating environment of FIG. 6 is only one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, tablets, and the like, multiprocessor systems, consumer electronics, mini computers, mainframe computers, distributed computing environments that include any of the above systems or devices, and the like.

Generally, embodiments are described in the general context of “computer readable instructions” being executed by one or more computing devices. Computer readable instructions are distributed via computer readable media as will be discussed below. Computer readable instructions can be implemented as program modules, such as functions, objects, Application Programming Interfaces (APIs), data structures, and the like, that perform particular tasks or implement particular abstract data types. Typically, the functionality of the computer readable instructions can be combined or distributed as desired in various environments.

FIG. 6 illustrates a system 600 comprising a computing device 602 configured to implement one or more embodiments provided herein. In one configuration, computing device 602 can include at least one processing unit 606 and memory 608. Depending on the exact configuration and type of computing device, memory 608 may be volatile, such as RAM, non-volatile, such as ROM, flash memory, etc., or some combination of the two. This configuration is illustrated in FIG. 6 by dashed line 604.

In these or other embodiments, device 602 can include additional features or functionality. For example, device 602 can also include additional storage such as removable storage or non-removable storage, including, but not limited to, magnetic storage, optical storage, and the like. Such additional storage is illustrated in FIG. 6 by storage 610. In some embodiments, computer readable instructions to implement one or more embodiments provided herein are in storage 610. Storage 610 can also store other computer readable instructions to implement an operating system, an application program, and the like. Computer readable instructions can be accessed in memory 608 for execution by processing unit 606, for example.

The term “computer readable media” as used herein includes computer storage media. Computer storage media includes volatile and nonvolatile, removable and non-removable media implemented in any method or technology for storage of information such as computer readable instructions or other data. Memory 608 and storage 610 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 602. Any such computer storage media can be part of device 602.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

Device 602 can include one or more input devices 614 such as keyboard, mouse, pen, voice input device, touch input device, infrared cameras, video input devices, or any other input device. One or more output devices 612 such as one or more displays, speakers, printers, or any other output device can also be included in device 602. The one or more input devices 614 and/or one or more output devices 612 can be connected to device 602 via a wired connection, wireless connection, or any combination thereof. In some embodiments, one or more input devices or output devices from another computing device can be used as input device(s) 614 or output device(s) 612 for computing device 602. Device 602 can also include one or more communication connections 616 that can facilitate communications with one or more other devices 620 by means of a communications network 618, which can be wired, wireless, or any combination thereof, and can include ad hoc networks, intranets, the Internet, or substantially any other communications network that can allow device 602 to communicate with at least one other computing device 620.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. An electronic workflow processing method in an electronic workflow processing system, comprising:
receiving a request for a project; the project comprising at least one document to be generated and processed for evaluation;
generating a data structure for an electronic workflow for the project, wherein the electronic workflow is divided into a plurality of workflow tasks for generating and evaluating the at least one document, and wherein the data structure reflects the plurality of workflow tasks;
generating, in the data structure, at least one decision point for each of the plurality of workflow tasks, wherein the at least one decision point includes one or more decision point options;
generating, in the data structure, a specific unique identifier for each of the one or more decision point options;
assigning a workflow task of the plurality of workflow tasks and at least one decision point to a user of a plurality of users based on the specific unique identifier, wherein the user of the plurality of users is assigned based at least in part on a user database and is recognized as an assigned user; and
receiving a response for the at least one decision point for the assigned workflow task of the plurality of workflow tasks from the user from the plurality of users and updating the data structure in order to process a next task of the plurality of workflow tasks based at least in part on the response, wherein processing of a total plurality of the plurality of workflow tasks iterates through and completes the project.

2. The method of claim 1, wherein a selected task of the plurality of workflow tasks in the data structure has multiple decision points.

3. The method of claim 2, further comprising:
generating at least one selectable link in the electronic workflow for the specific unique identifier for each of the one or more decision point options.

4. The method of claim 3, further comprising:
generating an alert comprising the at least one selectable link with the specific unique identifier; and
communicating the alert to the assigned user based on the specific unique identifier at an originating contact information, wherein the originating contact information is based at least in part upon the user database that specifies a user specific media associated with a user identification and includes an identity of the user of the plurality of users.

5. The method of claim 4, comprising:
receiving a response to the alert from the assigned user of the one or more decision point options via the selectable link in the alert, wherein the response to the alert includes the originating contact information that provides comparison of the user identification associated with the response to the alert with an expected user identification, wherein the expected user identification is based at least in part on the user database, and wherein the comparison confirms the identity of the user and authenticates the response to the alert; and
upon confirmation,
processing the at least one decision point for each of the plurality of workflow tasks associated with the one or more decision point options; and
updating the data structure of the electronic workflow based on the specific unique identifier associated with the processed at least one decision point for each of the plurality of workflow tasks.

6. (canceled)

7. The method of claim 4, wherein the alert is an email addressed to a user email address and the user identification is the user email address.

8. The method of claim 1, wherein the one or more decision point options includes one of approval, denial, and suggested edits.

9. The method of claim 5, wherein processing of the total plurality of the plurality of workflow tasks that completes the project occurs sequentially and the data structure for the electronic workflow is generated piecewise upon a confirmed workflow task being processed.

10. A workflow processing system for completing a project comprising:
a processor that executes computer executable components stored in a memory to generate a data structure for managing an electronic workflow associated with the project, wherein the computer executable components comprise:
a generator component that receives a request for the project and generates the data structure for managing the electronic workflow, the project comprising at least one document to be generated and processed for evaluation;
a tasks component that generates a plurality of workflow tasks corresponding to steps for generating and processing the at least one document; and
a unique identifier component that generates at least one decision point and a plurality of decision point options for each workflow task of the plurality of workflow tasks, that generates a unique identifier for each decision point option of the plurality of decision point options of the at least one decision point, and that associates the unique identifier to at least one user.

11. The system of claim 10, further comprising:
an assignment component that assigns each workflow task of the plurality of workflow tasks to a set of users that includes the at least one user associated with the unique identifier, wherein upon assignment, the unique identifier component updates the association of the each workflow task of the plurality of the workflow tasks to the at least one user associated with the unique identifier.

12. The system of claim 11, comprising:
a decision processing component that generates at least one selectable link in the electronic workflow for each decision point option of the plurality of decision points options of the at least one decision point for each workflow task of the plurality of workflow tasks, wherein the selectable link is associated with the unique identifier.

13. The system of claim 12, comprising:
an alert component that generates an alert comprising the at least one selectable link in the electronic workflow with the unique identifier; and
a communications component that communicates the alert to the at least one user associated with the unique identifier at an originating contact information, wherein the originating contact information is based at least in part upon a user database that specifies a user specific media associated with a user identification and includes an identity for each user of the set of users.

14. The system of claim 13, wherein the decision processing component:
receives a selection, based on the at least one selectable link, from the at least one user associated with the unique identifier via the selectable link in the electronic workflow such that the unique identifier is returned to the data structure managing the electronic workflow and wherein the selection includes the originating contact information; and
compares the user identification from the at least one user associated with the unique identifier with an expected user identification, the expected user identification based at least in part on the user database, to confirm the identity of the at least one user associated with the unique identifier and authenticate the selection of the decision point option; and
upon confirmation,
processes the each workflow task of the plurality of workflow tasks associated with the decision point option; and
updating the data structure of the electronic workflow based on the unique identifier associated with the processed workflow task.

15. (canceled)

16. The system of claim 13, wherein the alert is an email addressed to a user email address and the user identification is the user email address.

17. The system of claim 10, wherein the plurality of decision point options include approval, denial, and suggested edits.

18. The system of claim 12, wherein the decision processing component reverts to the task component for generation of a subsequent task upon receiving an approval decision point option.

19. A computer readable medium having instructions to control one or more processors configured to:
receive a request for a project; the project comprising at least one document to be generated and processed for evaluation;
generate a data structure for an electronic workflow that comprises a plurality of workflow tasks corresponding to steps for generating and processing documents and associating a plurality of users to perform the plurality of workflow tasks;
assign each workflow task of the plurality of workflow tasks to a first user and a second user of the plurality of users, wherein the assignment of the each workflow task of the plurality of workflow tasks designates an update to the data structure corresponding to the first user and the second user of the plurality of users;
generate a decision point for the first user and the second user of the plurality of users assigned the each workflow task of the plurality of workflow tasks; the decision point having one or more decision point options, wherein the one or more decision point options are associated with the each workflow task of the plurality of workflow tasks;
generate a unique identifier for each decision point option and the first user and the second user of the plurality of users;
generate at least one selectable link in the electronic workflow for each decision point option that is associated with the unique identifier;
generate an alert for each unique identifier, comprising the at least one selectable link with the unique identifier; and
communicate the alert to the first user and the second user of the plurality of users at an originating contact information, wherein the originating contact information is based at least in part upon a user database that specifies a user specific media associated with a user identification of the plurality of users.

20. The computer readable medium of claim 19, wherein the processors are further configured to:
receive a first selection from the first user of the one or more decision point options via the selectable link in the alert such that the unique identifier is returned to the electronic workflow and wherein the selection includes the originating contact information;
receive a second selection from the second user of the one or more decision point options via the selectable link in the alert such that the unique identifier is returned to the electronic workflow and wherein the selection includes the originating contact information;
compare a first user identification of the first user and a second user identification of the second user associated with the first selection of the first user and the second selection of the second user with each of an expected user identification, the each of the expected user identification based at least in part on the user database, to confirm the first user identification of the first user and the second user identification of the second user; and
authenticate the first selection of the first user and the second selection of the second user; and
upon authentication,
process the each workflow task of the plurality of workflow tasks associated with the one or more decision point options; and
update the data structure of the electronic workflow based on the unique identifier associated with the processed workflow task and the first user and the second user.
